(19) United States
(12) Patent Application Publication
(10) Pub. No.: US 2009/0119632 A1
(43) Pub. Date: May 7, 2009

(54) METHOD FOR SUPPORTING DETERMINATION OF DESIGN PROCESS ORDER

(76) Inventors: Makoto Kano, Yokohama-shi (JP); Akio Koide, Yokohama-shi (JP); Takayuki Osogami, Yamato-shi (JP); Toshihiro Takahashi, Yamato-shi (JP); Takeo Yoshizawa, Yamato-shi (JP)

Correspondence Address: IBM CORPORATION, T.J. WATSON RESEARCH CENTER, P.O. BOX 218, YORKTOWN HEIGHTS, NY, 10598, US

(21) Appl. No.: 12/262,275

(22) Filed: Oct. 31, 2008

(30) Foreign Application Priority Data
Nov. 1, 2007 (JP) 2007-285482

(51) Int. Cl. G06F 17/50

(52) U.S. Cl. 716/10

(57) ABSTRACT

A system and method which support determination of a design process order. The system includes: a storage device that stores constraint data indicating a strength of a constraint that is given to a respective design process from a respective of the other design processes; a detection unit that accesses the storage device to detect, from the constraint data, a loop of relationships concerning a design process receiving a constraint from another design process; a selection unit that accesses the storage device to select, from the detected loop, a pair capable of canceling the loop when the pair is deleted and having a minimum total constraint strength; and an output unit that deletes the selected constraint pair from the constraint data and outputs data indicating a constraint that is to be satisfied by each design process.

### CROSS REFERENCE TO RELATED APPLICATION

This application claims priority under 35 U.S.C. § 119 from Japanese Patent Application No. 2007285482 filed Nov. 1, 2007, the entire contents of which are incorporated herein by reference.

### BACKGROUND OF THE INVENTION

1. Field of the Invention

The present invention relates to a technique that supports determination of a design process order. More particularly, the present invention relates to a method for supporting determination of a design process order by a computer.

2. Description of the Related Art

Developing a product like an automobile requires a huge number of design processes. For example, a door is designed by a first design process, and an opening to which the door is to be installed is designed by a second design process. In addition, a larger number of design processes will be required as a product becomes more complicated and designed on a larger scale.

The design processes may depend on each other in some cases. For example, it is impossible to design the opening until the design for the door is completed. On the other hand, it might be impossible to design the door until the design for the opening is completed. In such a case, although one of the design processes should be conducted prior to the other, a return may occur to the former process in some cases after the latter design process is completed.

For background art concerning the optimization of the business processes, see Japanese Unexamined Patent Publication (Kokai) No. 2007-079868.

In the case where a large number of complicated design processes depend on each other, engineers can determine what process should be conducted first based on their intuition and experience. However, such determination may cause an increase in the number of processes added because of a return. The number of added processes may cause a delay in development time or an increase in development costs. To cope with the situation, a computer can be utilized, for example, to analyze a dependency relationship and determine a procedure order of design processes.

When developing a product, however, various exceptional situations may occur. For instance, when a design is changed in the preceding design process, the following design process that has been already started may be conducted again. Alternatively, if the priority for the job is changed in the following design process, a part of the job in the preceding design process has to be conducted again. For these reasons, a simply-determined single process order may not cope with such exceptional situations.

### SUMMARY OF THE INVENTION

Accordingly, it is an object of the present invention to provide a system, a program and a method to solve the above-stated problems. This object can be achieved by the combination of the features recited in independent claims of the present invention. Dependent claims thereof specify more advantageous specific examples of the present invention.

In order to cope with the above-stated problems, a first embodiment of the present invention provides a system that supports determination of a design process order. The system includes: a storage device that stores constraint data indicating a strength of a constraint that is given to a respective design process from the perspective of the other design processes; a detection unit that accesses the storage device to detect, from the constraint data, a loop of relationships concerning a design process receiving a constraint from another design process; a selection unit that accesses the storage device to select, from the detected loop, a pair capable of canceling the loop when the pair is deleted and having a minimum total constraint strength; and an output unit that deletes the selected constraint pair from the constraint data and outputs data indicating a constraint that is to be satisfied by each design process. Further, a program making a computer function as the system and a method for supporting determination of a design process order by the system are provided. Note that the above summary of the present invention does not recite all of the necessary features of the present invention, and the sub-combinations of these feature groups also can be inventions.

### BRIEF DESCRIPTION OF THE DRAWINGS

FIG. 1 illustrates an overall configuration of a computer 100 according to the present embodiment;

FIG. 2A illustrates an exemplary data configuration in a storage device 104 according to the present embodiment;

FIG. 2B illustrates an exemplary graph representing constraint data according to the present embodiment;

FIG. 3 illustrates a functional configuration of a support system 106 according to the present embodiment;

FIG. 4 illustrates the flow of the processing where the storage device 104 according to the present embodiment processes the constraint data and outputs the same;

FIG. 5 illustrates a first example of the constraint graph including an unnecessary or redundant constraint;

FIG. 6 illustrates a second example of the constraint graph including an unnecessary or redundant constraint;

FIG. 7 illustrates a third example of the constraint graph including an unnecessary or redundant constraint;

FIG. 8 illustrates the flow of the processing at S420 of FIG. 4 in detail;

FIG. 9 illustrates the flow of the processing at S840 of FIG. 8 in detail;

FIG. 10 illustrates the flow of the processing at S430 of FIG. 4 in detail;

FIG. 11A illustrates the flow of the processing at S1010 of FIG. 10 in detail;

FIG. 11B illustrates an exemplary graph representing the deletion of the constraint relationship at S1010 of FIG. 10;

FIG. 12A illustrates the flow of the processing at S1020 of FIG. 10 in detail;

FIG. 12B illustrates an exemplary graph representing the deletion of the constraint relationship at S1020 of FIG. 10;

FIG. 13A illustrates the flow of the processing at S1030 of FIG. 10 in detail;

FIG. 13B illustrates an exemplary graph representing the deletion of the constraint relationship at S1030 of FIG. 10;

FIG. 14 illustrates an exemplary constraint graph output from the output unit 350 of the present embodiment; and

FIG. 15 shows an exemplary hardware configuration of a computer 100 according to the present embodiment.

### DETAILED DESCRIPTION OF THE PREFERRED EMBODIMENTS

The following describes the present invention by way of embodiments. However, the following embodiments do not limit the invention according to the claims of the present invention, and all of the features described in the embodiments are not always essential to solving means of the present invention.

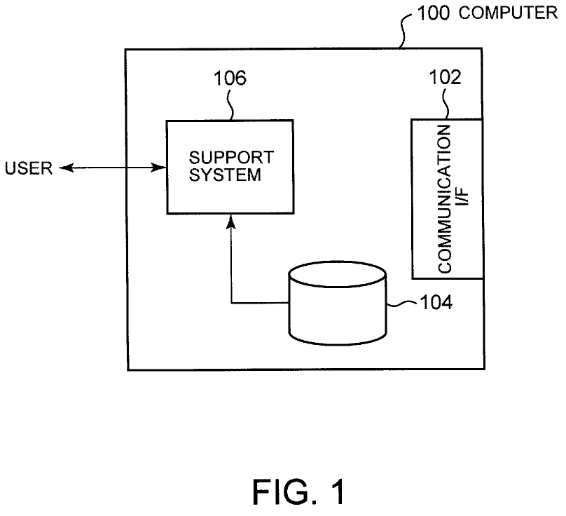

FIG. 1 illustrates an overall configuration of a computer 100 according to the present embodiment. The computer 100 includes, as basic hardware, a communication interface 102 such as a communication interface card and a storage device 104 such as a hard disk drive. Further, the computer 100 functions as a support system 106 by making an operation device such as a CPU execute a program read out from the storage device 104.

For a plurality of design processes to develop a product, the support system 106 receives an input from a user about constraints between design processes, and determines a design process order so as to satisfy such constraints as much as possible and outputs the same. The user conducts the product development in accordance with this process order to reduce the returning in process due to the design change, thus enabling a reduction in development time or development cost.

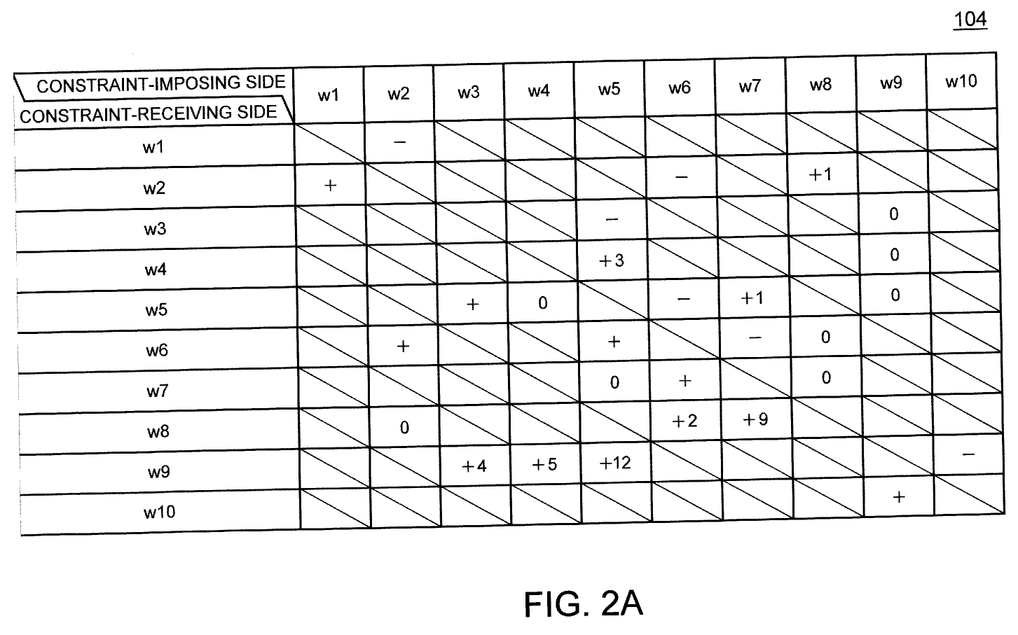

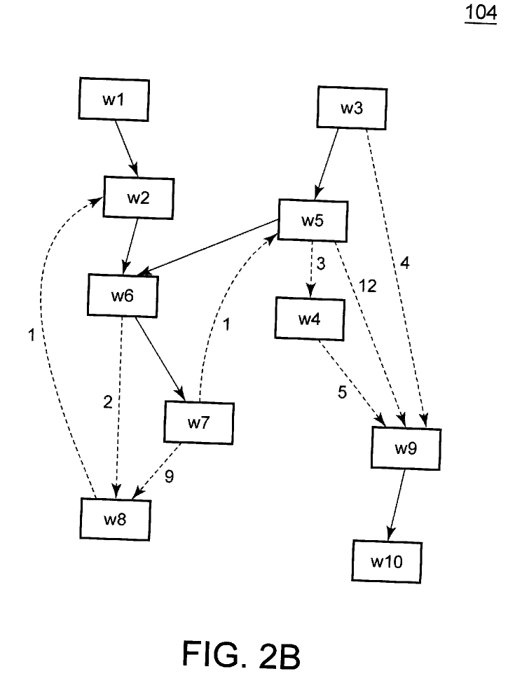

FIG. 2A illustrates an exemplary data configuration in the storage device 104 according to the present embodiment. The storage device 104 stores constraint data. The constraint data indicates a strength of a constraint that a respective design process receives from each of the other design processes. This data can be represented in the form of an asymmetric matrix as in FIG. 2A. FIG. 2B illustrates an exemplary graph (DAG: Directed Acyclic Graph) representing the constraint data according to the present embodiment.

Each of w1 to w10 indicates a design process, which is represented as a node in the graph. A strength of the constraint is defined between one design process and another design process, which is represented as an edge in the graph. This edge is a directed edge with a strength of the constraint as a weight that is directed from a design process imposing the constraint to a design process receiving the constraint.

More specifically, the design process w1 imposes a constraint on the design process w2. This constraint is of a nature that has to be satisfied necessarily. As for such a constraint, its strength may not be defined but a constraint with infinite strength can be defined. In FIG. 2A, this constraint is represented as “+” or “−”. In FIG. 2B, this constraint is represented as a directed edge in a solid line.

The design process w2 also receives a constraint from the design process w8. This constraint is of a nature that, unless this constraint is satisfied, a return occurs in the process, and a strength of the constraint is represented as a time required for a return. The required time for a return may be 1 unit of time, for example (e.g., this corresponds to the case where one person works for one hour). In FIG. 2A, the strength of this constraint is represented as +1. In FIG. 2B, this constraint is represented as a directed edge in a dotted line.

Herein, attention is given to the design process w2, the design process w6 and the design process w8. The design process w2 imposes a constraint on the design process w6, the design process w6 imposes a constraint on the design process w8, and the design process w8 imposes a constraint on the design process w2. In this way, constraint data may contain a loop of relationships concerning a certain design process receiving a constraint from another design process.

Unavoidably, one of the constraints will not be satisfied in the case where the constraint data contains such a loop. However, if a constraint that will not be satisfied is selected freely, then the time required for a return may be excessively long. To cope with this, it is possible that the required time for a return can be minimized by using a technique called exhaustive search.

For instance, assume that each of the w1 to w10 is processed in all possible process orders irrespective of the constraints thereof. Then, the required time for a return is calculated in each of the process orders. This required time is calculated by scanning the storage device 104 and summing the time of the return corresponding to a constraint that will not be satisfied when the process is conducted in such an order.

Then, the support system 106 determines the order that can minimize the total required time for a return as the order by which w1 to w10 are to be processed. Such exhaustive search allows the support system 106 to determine the process order that can minimize the total time required for a return. According to such exhaustive search, however, if the total number of the design processes is large, the processing will require a huge amount of time, thus leading to a possibility that the process will not be completed in a practical time period.

On the other hand, according to the support system 106 of the present embodiment, the process order to minimize the required time for a return is determined by a significant speedy procedure that can be completed in a practical time period using an already-existing computer.

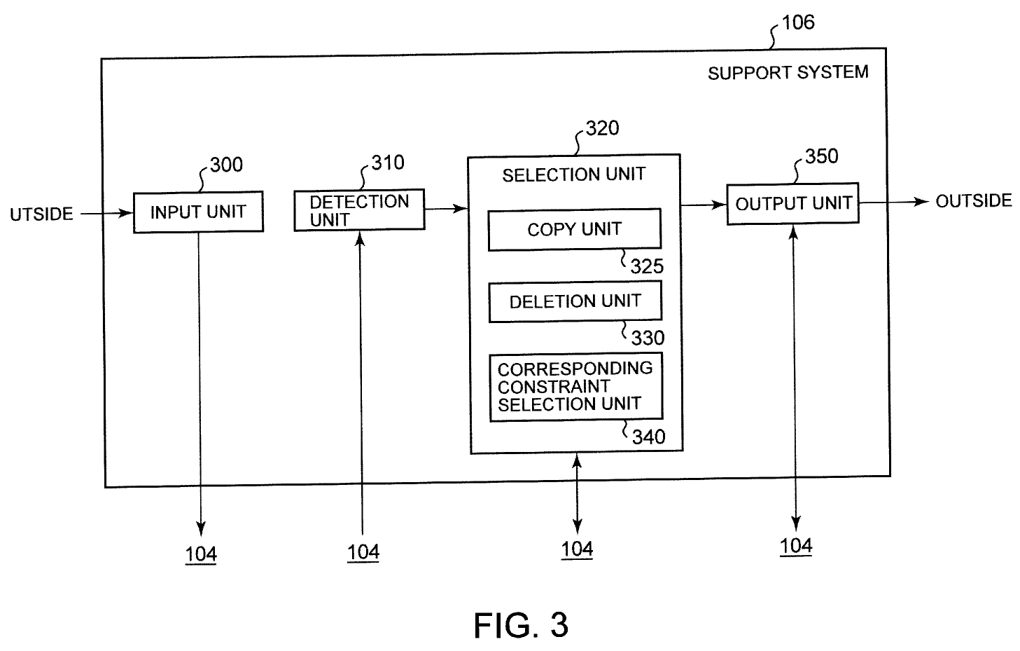

FIG. 3 illustrates a functional configuration of the support system 106 according to the present embodiment. The support system 106 includes an input unit 300, a detection unit 310, a selection unit 320, and an output unit 350. The input unit 300 receives an input of constraint data from a user and stores the same in the storage device 104. The detection unit 310 accesses the storage device 104 to detect a loop of relationships concerning a certain design process receiving a constraint from another design process.

The selection unit 320 accesses the storage device 104 to select, from the thus detected loop, a pair capable of canceling the loop when the pair is deleted and having a minimum total constraint strength. When the constraint data is represented as the graph, this constraint pair corresponds to a directed edge pair capable of canceling the loop in the graph when the pair is deleted and having a minimum total weight. More specifically, the selection unit 320 includes a copy unit 325, a deletion unit 330, and a corresponding constraint selection unit 340. The copy unit 325 generates copy data that is a copy of the constraint data and stores the same in the storage device 104.

The deletion unit 330 accesses the storage device 104 to delete, in accordance with a predetermined procedure, a design process and a constraint that do not affect a strength of a constraint to be deleted for cancelling the loop from the copy data. For instance, obviously a constraint that is not included in the loop should not be deleted. Further, a very strong constraint will not be selected as the constraint to be deleted because the strength of the constraint to be deleted should be minimized. Thus, the deletion unit 330 deletes, from the copy data, such constraints that will not be deleted obviously.

The corresponding constraint selection unit 340 selects, from the copy data from which the design process and the constraint have been deleted, a pair capable of canceling the loop when the pair is deleted, and having a minimum total constraint strength. Then, the corresponding constraint selection unit 340 selects a constraint pair corresponding to the selected constraint pair from the original constraint data. The output unit 350 accesses the storage device 104 to delete the constraint pair selected by the corresponding constraint selection unit 340 from the original constraint data, and outputs data indicating a constraint that is to be satisfied by each design process.

In this way, in the support system 106 according to the present embodiment, the selection unit 320 does not select a constraint pair from the constraint data directly. Instead, the corresponding constraint selection unit 340 selects a constraint pair from a graph obtained by decreasing a scale of the copy data by the copy unit 325. Thereby, the processing time for determining a constraint pair to be selected can be shortened.

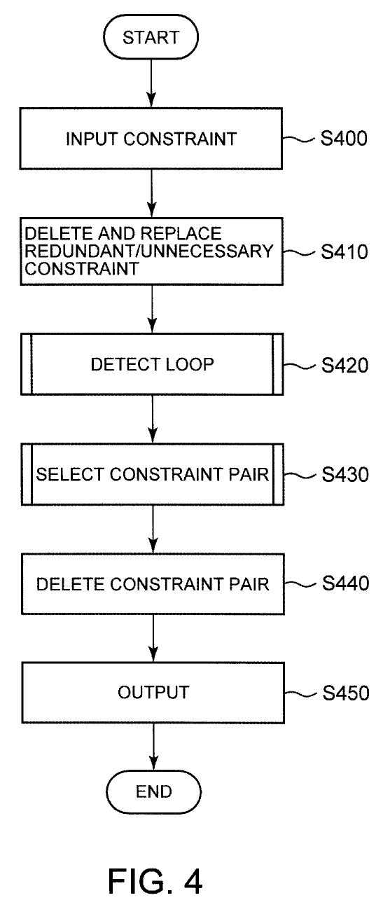

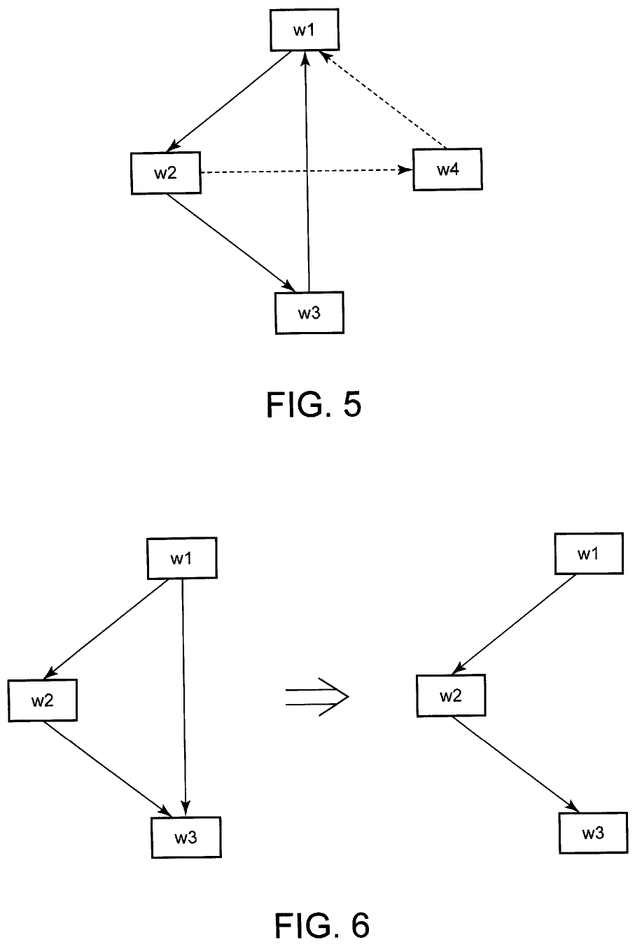

FIG. 4 illustrates the flow of the processing where the storage device 104 according to the present embodiment processes the constraint data and outputs the same. The input unit 300 receives an input of the constraint data and stores the input constraint data in the storage device 104 (S400). Next, the input unit 300 removes a contradictory constraint that cannot be satisfied, and a redundant or unnecessary constraint (S410). FIGS. 5 to 7 illustrate a specific example.

FIG. 5 illustrates a first example of the constraint graph including an unnecessary or redundant constraint. The design process w1 imposes a constraint on the design process w2, the design process w2 imposes a constraint on the design process w4, and the design process w4 imposes a constraint on the design process w1. Note that the constraint from w2 on w4 and the constraint from w4 on w1 are not of a nature that has to be necessarily satisfied, and therefore no contradiction occurs here.

On the other hand, the design process w1 imposes a constraint on the design process w2, the design process w2 imposes a constraint on the design process w3, and the design process w3 imposes a constraint on the design process w1. Thus, constrains must be satisfied. If the constraints are not satisfied, a return simply will not occur.

In this way, if all of the constraints included in the loop have to be satisfied, the input unit 300 receives an input from a user for changing the constraint data stored in the storage device 104. For instance, the input unit 300 displays a message indicating that there are contradictory constraints, which are associated with identification information of the contradictory constraints (e.g., symbols such as w1→w2, w2→w3, w3→w1), so as to let the user input what constraint is to be deleted. In response to this input, the constraint data stored in the storage device 104 is changed.

FIG. 6 illustrates a second example of the constraint graph including an unnecessary or redundant constraint. In this second example, the detection unit 310 deletes a constraint that is determined transitively by a plurality of other constraints. More specifically, in this second example, the design process w1 is one example of a sixth design process according to the present invention. The design process w2 is one example of a seventh design process according to the present invention. The design process w3 is one example of an eighth design process according to the present invention.

The design process w2 receives, from the design process w1, a constraint of a nature that has to be satisfied. The design process w3 receives, from the design process w2, a constraint of a nature that has to be satisfied. The design process w3 receives, from the design process w1, a constraint of a nature that has to be satisfied. Then, the design process w2 does not receive a constraint from any other design processes. The design process w2 does not impose a constraint on any other design processes. In this case, the detection unit 310 deletes the constraint that the design process w3 receives from the design process w1, which is of a nature that has to be satisfied from the constraint data.

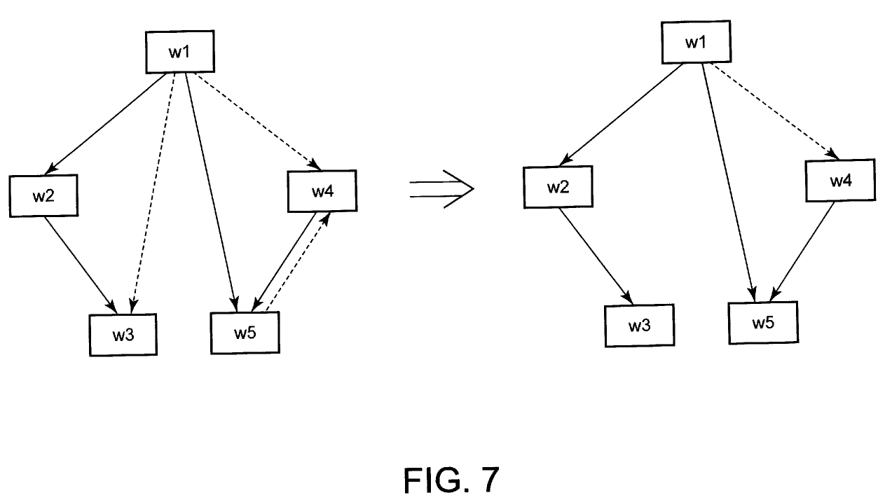

FIG. 7 illustrates a third example of the constraint graph including an unnecessary or redundant constraint. In this third example, if a constraint of a nature that has to be satisfied and a constraint of a nature that generates a return unless it is satisfied exists between a design process and another design process, the detection unit 310 deletes the constraint that generates a return unless it is satisfied by the constraint data.

More specifically, in the third example, the design process w5 receives, from the design process w4, a constraint of a nature that has to be satisfied. The design process w4 receives, from the design process w5, a constraint of a nature that generates a return unless it is satisfied. In such a case, the detection unit 310 deletes the constraint that generates a return unless it is satisfied by the constraint data.

Further, in the third example, the design process w3 receives, from the design process w1, a constraint of a nature that generates a return unless it is satisfied. On the other hand, the design process w2 receives, from the design process w1, a constraint of a nature that has to be satisfied, and the design process w3 receives, from the design process w2, a constraint of a nature that has to be satisfied. As a result, the design process w3 receives transitively, from the design process w1, a constraint of a nature that has to be satisfied.

Therefore, a constraint of a nature that has to be satisfied and a constraint of a nature that generates a return unless it is satisfied exist between the design process w3 and the design process w1. In such a case, the detection unit 310 deletes the constraint of a nature that generates a return unless it is satisfied from the constraint data. As a result, the constraint, which the design process w3 receives from the design process w1, of a nature that generates a return unless it is satisfied, is deleted from the constraint data.

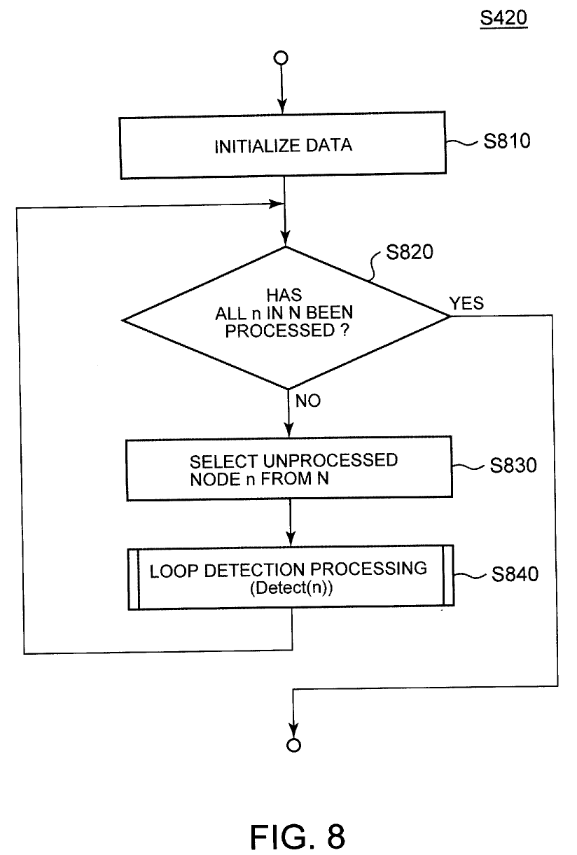

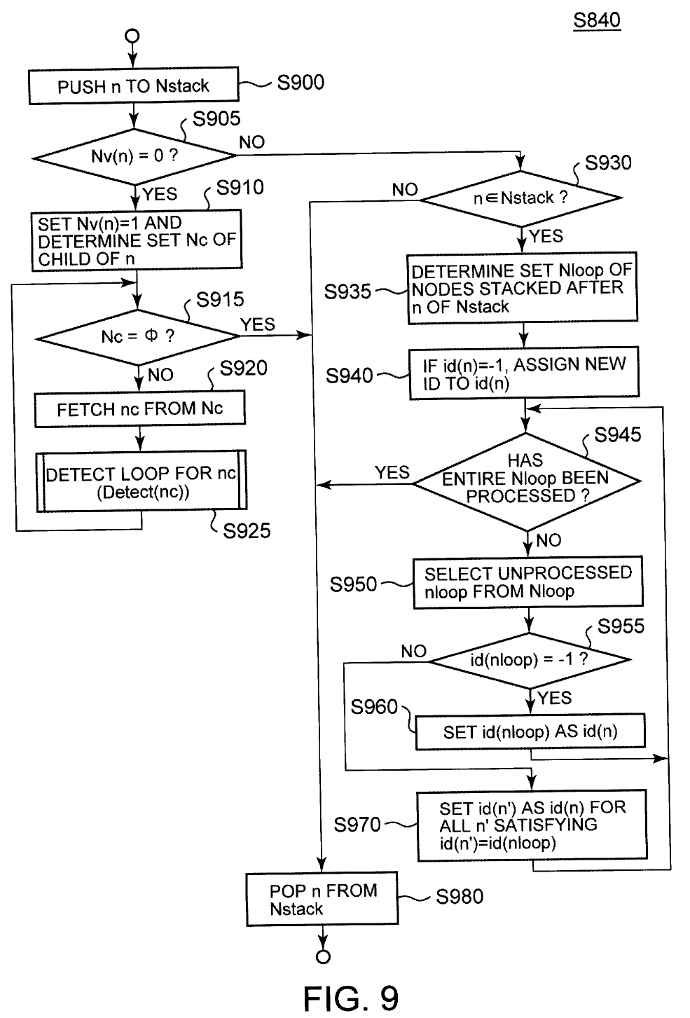

Now, the description returns to FIG. 4. Next, the detection unit 310 deletes a constraint as stated above by the various processing, or detects a loop of the constraints from the changed constraint data (S420). FIGS. 8 and 9 illustrate a specific example of the processing.

FIG. 8 illustrates the flow of the processing at S420 of FIG. 4 in detail. Firstly, the detection unit 310 initializes various data for detecting a loop (S810). In this initialization process, firstly, a constraint graph is defined, which represents the constraint data using nodes and edges. More specifically, the detection unit 310 designates a set N as a set of nodes representing respective design processes, and a set E as a set of edges representing respective constraints.

The nodes and the edges are numbered serially starting from 1 as identification information. In this case, each of N and E may be stored in a storage device such as RAM in the form of an array of identification information for identifying each element in the set, for example, so as to permit the reference and change by an operation conducted later.

The detection unit 310 further reserves a storage area of Nv(n) as a set of flags in the storage device. Nv(n) represents flags indicating whether a node n has been visited or not (meaning that the node n has been processed by a loop detection processing of FIG. 9). For instance, if Nv(1)=1, it is indicated that the node 1 has been visited. Nv(n) may be implemented as an integer-type or a logical value-type array variable.

The detection unit 310 further reserves a storage area of id(n) as a set of id numbers in the storage device. id(n) represents an ID of a group to which a node n belongs. At the stage of the initialization process, none of the nodes belong to a group, and therefore the detection unit 310 initializes as id(n)=−1 for all n's.

The detection unit 310 further reserves a stack-type data storage area Nstack in the storage device. Hereinafter, pushing an element to this data storage area is referred to as simply pushing an element to Nstack, and popping an element from this data storage area is referred to as simply popping an element from Nstack.

Next, the detection unit 310 judges whether the processing of all n in the set N has been completed or not (S820). For instance, if Nv(n)=1 for all nodes n in the set N, it is judged that the processing of all n in the set N has been completed.

If the processing has been completed (S820: YES), the support system 106 ends the processing of FIG. 8. On the other hand, if the processing has not been completed (S820: NO), the detection unit 310 selects an unprocessed node from the set N. The selected node is made a node n. Then, the detection unit 310 conducts a loop detection processing for the node n (S840).

The loop detection processing may be implemented by a function of a functional programming language such as C language or by a method of an object-oriented programming language such as Java® language. In such a case, a node n as a target of the loop detection processing (in a strict sense, a numerical value n as its serial number) may be given as an argument of the function or the method. In this case, various sets and variables other than the numerical value n are referred to by a same symbol in the called function or method as so-called global variables.

When the processing at S840 described later is completed, the detection unit 310 returns the procedure to S820, where a similar processing is repeated with respect to an unprocessed next node n.

FIG. 9 illustrates the flow of the processing at S840 of FIG. 8 in detail. Firstly, the detection unit 310 pushes the node n given as an argument, for example, to Nstack (S900).

Next, the detection unit 310 judges whether Nv(n)=0 or not (S905). If Nv(n)=0 (S905: YES), the detection unit 310 sets Nv(n)=1 (S910). The detection unit 310 further detects another node receiving a constraint from the node n (referred to as a child of the node n) and sets a set thereof as Nc. The entity of the set Nc is an array including serial numbers of nodes, whose storage area may be reserved in the storage device.

Next, the detection unit 310 judges whether Nc is a null set or not (S915). If Nc is not a null set (S915: NO), the detection unit 310 fetches a node nc from Nc (S920). nc is deleted from Nc. Then, the detection unit 310 conducts the loop detection processing with respect to the node nc recursively (S925). This processing may be implemented by calling a function or a method setting the node nc (precisely, the serial number nc) as an argument recursively.

When the loop detection processing is completed, the detection unit 310 returns the procedure to S915, where the processing is conducted with respect to the next node nc included in Nc. On the other hand, if Nc is a null set (S915: YES), the detection unit 310 pops a node n from Nstack (S980) and ends the processing of FIG. 9.

On the other hand, if Nv(n)=0 does not hold (S905: NO), the detection unit 310 judges whether Nstack includes a node n or not except for the top of Nstack (S930). If Nstack does not include a node n (S930: NO), the detection unit 310 pops a node n from Nstack (S980), and ends the processing of FIG. 9.

On the other hand, if Nstack includes a node n (S930: YES), the detection unit 310 determines a set of nodes residing on the stack top side with reference to the node n in Nstack (including the node n itself at the stack top) (S935). The set is made as Nloop.

Next, the detection unit 310 judges whether id(n)=−1 or not (S940). If id(n)=−1, the detection unit 310 assigns a new ID to id(n). The new ID may be an integer the largest next after the maximum integer that has been already set as the value of id(m) for any node m, for example. If id(m) has not been set for any node m, the new Id will be 0.

Next, the detection unit 310 judges whether the processing setting id(nloop) has been completed for each of all nodes (referred to as nloop) included in the Nloop (S945). If it has not been completed (S945: NO), the detection unit 310 selects nloop that is an unprocessed node from Nloop (S950).

The detection unit 310 judges whether id(nloop)=−1 or not (S955). If id(nloop)=−1 (S955: YES), the detection unit 310 sets the value of id(nloop) at the same value of id(n) (S960). On the other hand, if id(nloop)=−1 does not hold (S955: NO), the detection unit 310 searches all n's whose ids(n′) are the same as id(nloop) from N, and sets the value of id(n′) for each of the searched n's at the same value of id(n) (S970).

Then, the detection unit 310 returns the procedure to S945, where the processing of setting a value for id(nloop) is repeated until the processing for the entire Nloop has been completed. If the processing has been completed for the entire Nloop (S945: YES), the detection unit 310 pops a node n from Nstack (S980) and ends the processing of FIG. 9.

As a result of the above-stated processing, the same id value is assigned to nodes included in one loop. For instance, if a node n and a node m are included in a same loop, id(n) will be equal to id(m). Thereby, it can be distinguished how many loops are included in the constraint data, and what kind of nodes each loop includes.

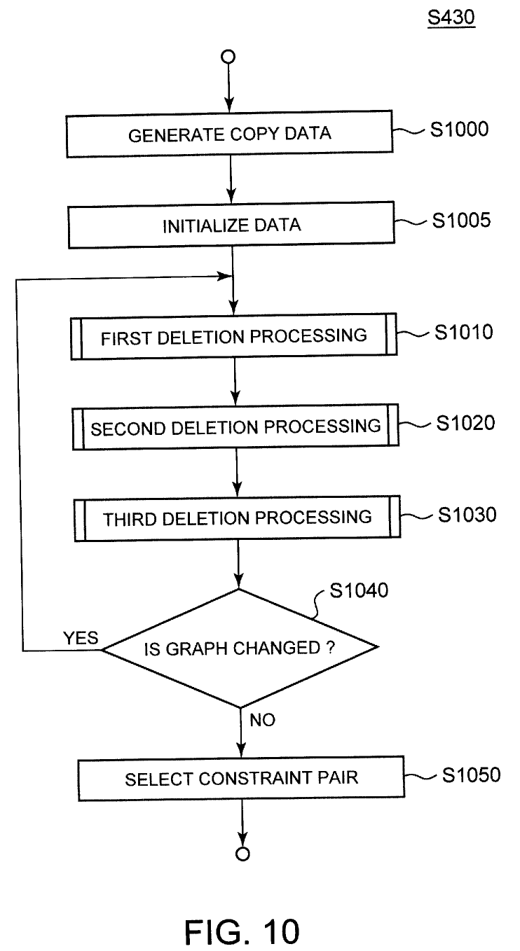

The description returns to FIG. 4. Next, the selection unit 320 selects a constraint pair to be deleted for cancelling the loop (S430). FIG. 10 illustrates the details of the processing.

FIG. 10 illustrates the flow of the processing at S430 of FIG. 4 in detail. The copy unit 325 generates copy data that is a copy of the constraint data (S1000). The selection unit 320 initializes various data used for the following processing (S1005).

More specifically, the selection unit 320 designates a set N as a set of nodes representing respective design processes, and a set E as a set of edges representing respective constraints. The nodes and the edges are numbered serially starting from 1 as identification information. In this case, each of N and E may be stored in a storage device such as RAM in the form of an array of identification information for identifying each element in the set, for example, so as to permit the reference and change by an operation conducted later.

The selection unit 320 further defines sets of edges Eown1(e) and Eown2(e) for respective edges e. That is, for example, the selection unit 320 reserves storage areas of the edge set for Eown1 in number corresponding to the number of edges in the storage device. Further, the selection unit 320 reserves storage areas of the edge set for Eown2 in number corresponding to the number of edges in the storage device.

Then, the selection unit 320 initializes Eown1(e) for each edge e using a set including only the edge e itself. The selection unit 320 initializes Eown2(e) for each edge e using a null set.

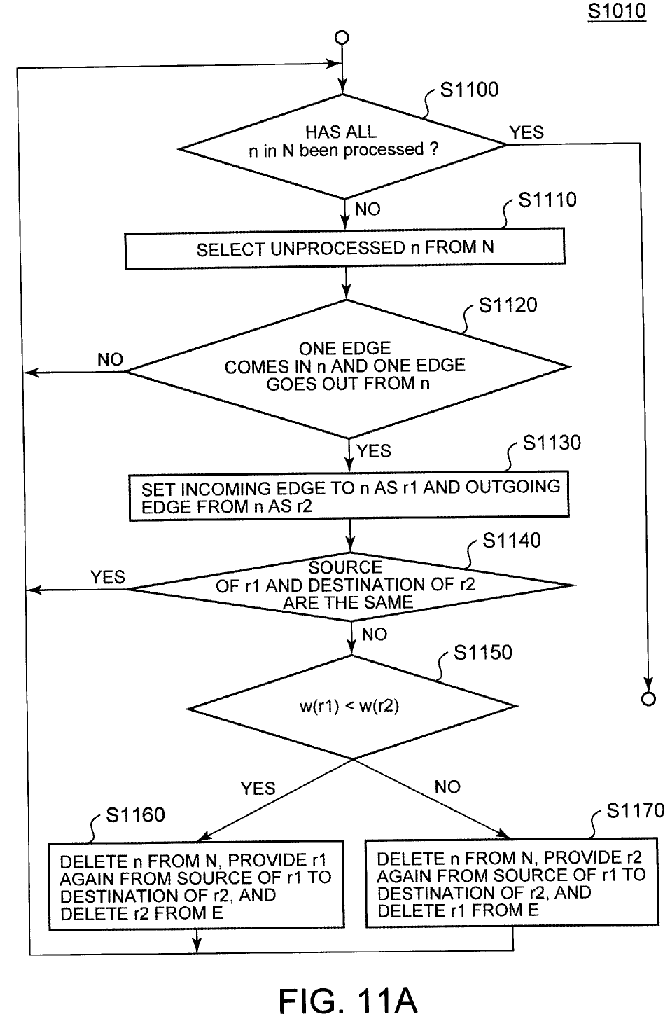

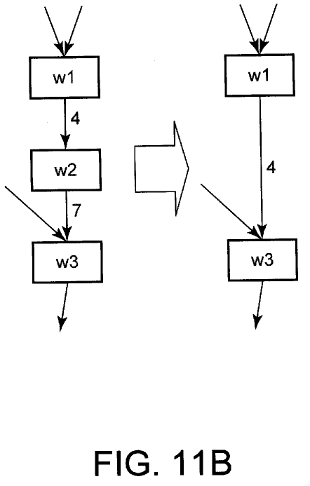

Next, the deletion unit 330 conducts first deletion processing (S1010). FIGS. 11A and 11B illustrate the details of the processing.

FIG. 11A illustrates the flow of the processing at S1010 of FIG. 10 in detail. Firstly, the deletion unit 330 judges whether the processing has been completed for all nodes n included in the set N (S1100). If the processing has been completed for all nodes n (S1100: YES), the deletion unit 330 ends the first deletion processing of FIG. 11A.

If some nodes n have not been processed, the deletion unit 330 selects one of the unprocessed nodes n from the set N (S1110). Then, the deletion unit 330 judges whether one edge comes in the selected node n and one edge goes out from the selected node s or not (S1120).

If one edge comes in the selected node n and one edge goes out from the selected node s or not (S1120: YES), the deletion unit 330 sets the incoming edge to the node n as r1 and the outgoing edge from the node n as r2 (S1130).

Then, the deletion unit 330 judges whether the node at the source of the edge r1 and the node at the destination of the edge r2 are the same or not (S1140). If they are the same (S1140: YES), the deletion unit 330 returns the procedure to S1100, where judgment is made with respect to the next node.

If they are not the same (S1140: NO), the deletion unit 330 compares a strength w(r1) of the constraint represented by the edge r1 with a strength w(r2) of the constraint represented by the edge r2 (S1150). If w(r1)<w(r2) (S1150: YES), the deletion unit 330 deletes the node n from the set N (S1160). The deletion unit 330 further provides the edge r1 again from the source node of the edge r1 to the destination node of the edge r2, and deletes the edge r2 from the set E.

If w(r1)<w(r2) does not hold (S1150: NO), the deletion unit 330 deletes the node n from the set N (S1170). The deletion unit 330 further provides the edge r2 again from the source node of the edge r1 to the destination node of the edge r2, and deletes the edge r1 from the set E. Then, the deletion unit 330 returns the procedure to S1100, where the processing is repeated with respect to the next node n.

FIG. 11B illustrates an exemplary graph representing the deletion of the constraint relationship at S1010 of FIG. 10. In this example, the design process w1 is one example of a third design process according to the present invention, the design process w2 is one example of a fourth design process according to the present invention, and the design process w3 is one example of a fifth design process according to the present invention.

Then, the design process w2 receives a constraint with a third strength, e.g., a constraint indicating the generation of a return corresponding to 4 unit time, from the design process w1. The design process w3 receives a constraint with a fourth strength, e.g., a constraint indicating the generation of a return corresponding to 7 w2 does not receive a constraint from any other design processes, and the design process w2 does not impose a constraint on any other design processes.

In this case, the deletion unit 330 replaces these constraints with a smaller constraint between the constraints with the third and the fourth strengths that the design process w3 receives from the design process w1. That is, in this case, the third constraint strength is 4 unit time, which is smaller than the fourth constraint strength that is 7 unit time, and therefore these constraints are replaced with the constraint of 4 units time that the design process w3 receives from the design process w5.

In this example, the time of a return generated due to the design process w2 is determined depending on the order of the relationship with the design processes w1 and w3. For instance, assuming that the design process w3 is processed after the design process w1, a return will not occur if the processing is conducted in the order of the design processes w1, w2 and w3.

On the other hand, assuming that the design process w1 is processed after the design process w3, the best way will be to process in the order of the design processes w3, w2, and w1 in terms of the minimization of a return. In this case, however, a return of 4 units time will occur.

In this way, whether the design process w1 is processed before the design process w3 or after the design process w3, a return of 7 units time defined between the design processes w2 and w3 will not occur as long as the other design processes are processed in the best order.

Thus, the deletion unit 330 deletes such a constraint that will not generate a return from the copy data. This is because such a constraint is of a nature that has to be satisfied necessarily, and is never deleted even to cancel a loop.

Herein, which one of the design processes w1 and w3 is to be processed first is determined based on the relationship with the other design processes.

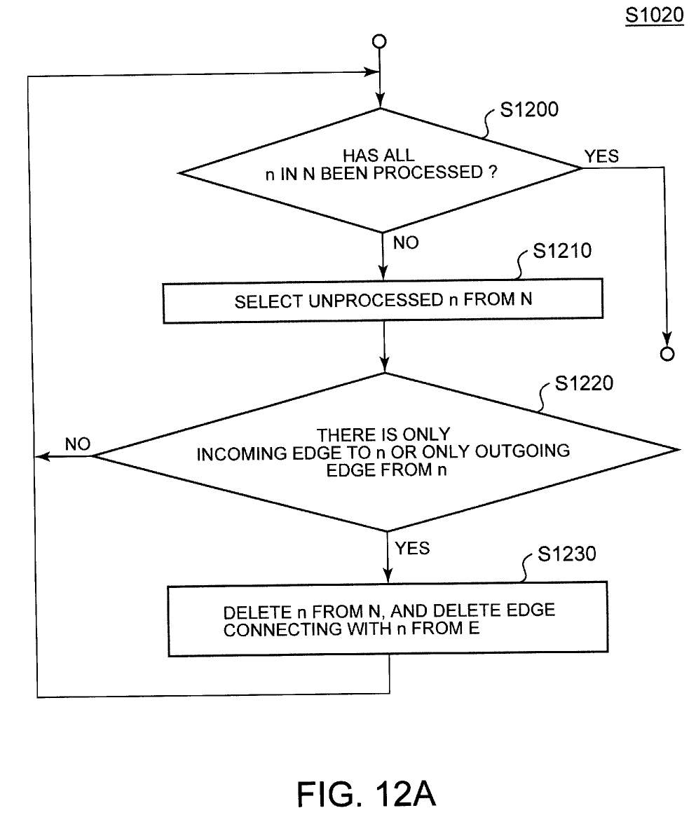

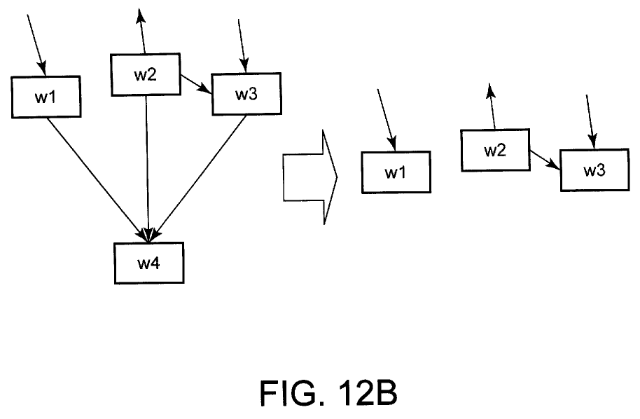

The description returns to FIG. 10. Next, the deletion unit 330 conducts a second deletion process (S1020). FIGS. 12A and 12B illustrate the details of the processing.

FIG. 12A illustrates the flow of the processing at S1020 of FIG. 10 in detail. The deletion unit 330 judges whether the processing at S1020 has been completed for all nodes n included in the set N (S1200). If the processing has been completed (S1200: YES), the deletion unit 330 ends the second deletion processing of FIG. 12A.

If the processing has not been completed (S1200: NO), the deletion unit 330 selects an unprocessed node from the set N (S1210). The selected node is made a node n. Then, the deletion unit 330 judges whether there is only an incoming edge to the node n or only an outgoing edge from the node n (S1220).

If there is only an incoming edge or only an outgoing edge (S1220: YES), the deletion unit 330 deletes the node n from the set N, and deletes an edge connecting with the node n from the set E (S1230). Then, the deletion unit 330 returns the procedure to S1200, where the processing of FIG. 12A is repeated with respect to other nodes.

FIG. 12B illustrates an exemplary graph representing the deletion of the constraint relationship at S1020 of FIG. 10. In this example, there are only incoming edges at the design process w4. That is, the design process w4 receives a constraint from at least any one design process, but does not impose a constraint on any other design processes. In such a case, the deletion unit 330 deletes the design process w4 from the copy data.

Additionally, the deletion unit 330 deletes a design process including only outgoing edges, i.e., a design process that imposes a constraint on at least any one design process and does not receive a constraint from any other design processes, from the copy data. In this way, the design process that does not affect the cancellation of the loop is deleted from the copy data for shortening the time required for the following process.

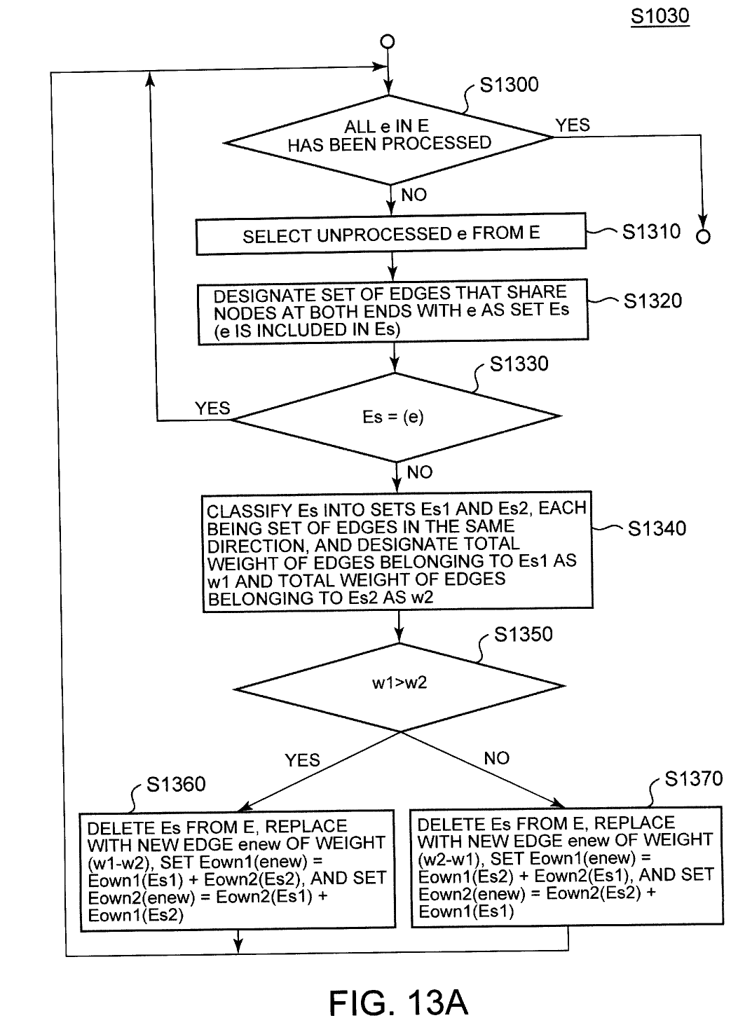

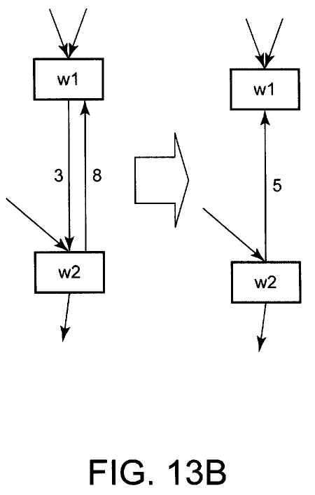

The description returns to FIG. 10. Next, the deletion unit 330 conducts third deletion processing (S1030). FIGS. 13A and 13B illustrate the details of the processing.

FIG. 13A illustrates the flow of the processing at S1030 of FIG. 10 in detail. The deletion unit 330 judges whether the processing at S1030 has been completed for all edges included in the set E (S1300). If the processing has been completed (S1300: YES), the deletion unit 330 ends the third deletion processing of FIG. 13A.

If some edges have not been processed yet (S1300: NO), the deletion unit 330 selects an unprocessed edge from the set E (S1310). The selected edge is made an edge e. Then, the deletion unit 330 searches an edge that shares the nodes at both ends with the edge e, and designates a set of the searched edges as a set Es.

For instance, in the case where the edge e indicates a constraint with a first strength that a first design process receives from a second design process, an edge in the same direction as this edge, i.e., another edge representing another constraint that the first design process receives from the second design process is selected as an element of the set Es. Further, an edge in the direction opposite to the edge e, i.e., another edge representing a constraint that the second design process receives from the first design process also is selected as an element of the set Es. The set Es includes the edge e itself as well.

Next, the deletion unit 330 judges whether the element of the set Es includes only the edge e or not (S1330). If the element of the set Es includes only the edge e (S1330: YES), the deletion unit 330 returns the procedure to S1300, where the processing is repeated with respect to other edges e included in the set E.

If the element of the set Es is not only the edge e (S1330: NO), the deletion unit 330 classifies the set Es into two sets Es1 and Es2 (S1340). The set Es1 indicates edges in the same direction as the edge e, and the set Es2 indicates edges in the direction opposite to the edge e.

The deletion unit 330 further calculates a weight of edges included in the set Es1, i.e., the total strength of the constraints. The total strength of the constraints may be a total of the required time for returning in the present embodiment, for example. Assume that the total value is w1.

Similarly, the deletion unit 330 calculates a weight of edges included in the set Es2, i.e., the total strength of the constraints. The total strength of the constraints may be a total of the required time for returning in the present embodiment, for example. Assume that the total value is w2.

Next, the deletion unit 330 compares the total value w1 with the total value w2 (S1350). If the total value w1 is larger than the total value w2 (S1350: YES), the deletion unit 330 deletes the set Es from the set E. Then, each edge included in the set Es is replaced with a new edge, “enew” whose weight corresponds to a difference obtained by subtracting the total value w2 from the total value w1.

A new serial number (e.g., a value larger than the maximum value of the serial value that has been already used) is assigned to the edge enew. The edge enew is in the same direction as the edge e. That is, the edge enew is an edge extending from the node at the source of the edge e to the node at the destination of the edge e.

Further, in order to facilitate the later recognition of a correspondence relationship between the copy data and the original constraint data, it is desirable to associate the edge before the replacement with the edge after the replacement. More specifically, the deletion unit 330 substitutes a variable Eown1(enew) representing a set with a sum of sets of Eown1(Es1) and Eown2(Es2). The deletion unit 330 further substitutes a variable Eown2(enew) representing a set with a sum of sets of Eown2(Es1) and Eown1(Es2).

Herein, Eown1(Es1) represents a sum of sets of variables Eown1 concerning respective edges included in the set Es1, and Eown2(Es2) represents a sum of sets of variables Eown2 concerning respective edges included in the set Es2. Eown2(Es1) represents a sum of sets of variables Eown2 concerning respective edges included in the set Es1, and Eown1(Es2) represents a sum of sets of variables Eown1 concerning respective edges included in the set Es2.

On the other hand, if the total value w1 is smaller than the total value w2 (S1350: NO), the deletion unit 330 deletes the set Es from the set E. Then, each edge included in the set Es is replaced with a new edge enew whose weight corresponds to a difference obtained by subtracting the total value w1 from the total value w2. That is, the edge enew is an edge extending from the node at the destination of the edge e to the node at the source of the edge e.

Further, the deletion unit 330 substitutes a variable Eown1(enew) representing a set with a sum of sets of Eown1(Es2) and Eown2(Es1). The deletion unit 330 further substitutes a variable Eown2(enew) representing a set with a sum of sets of Eown2(Es2) and Eown1(Es1). When the above processing has been completed, the deletion unit 330 returns the procedure to S1300, and the processing is repeated with respect to the next edge.

FIG. 13B illustrates an exemplary graph representing the deletion of the constraint relationship at S1030 of FIG. 10. The design process w1 is one example of a first design process according to the present invention, and the design process w2 is one example of a second design process according to the present invention. The design process w1 receives, from the design process w2, a constraint requiring the time of 3 unit time that is one example of a first strength. The design process w2 receives, from the design process w1, a constraint requiring the time of 8 unit time that is one example of a second strength.

In this example, since the second strength is larger than the first strength, the original constraints are replaced with a constraint of a strength corresponding to a difference between the first and the second strengths that the design process w2 receives from the design process w1. As a result, the design process w1 receives, from the design process w2, a constraint with a required time of 5 units time.

The description returns to FIG. 10. Next, the deletion unit 330 judges whether the first to the third deletion processing causes a change in the constraint graph, i.e., whether there is an edge or a node that has been replaced or deleted (S1040). If there is such an edge or a node (S1040: YES), the deletion unit 330 returns the procedure to S1010, so as to repeat a similar process with respect to the copy data until no design process capable of being deleted or replaced is left.

On the other hand, if there is no design process capable of being deleted or replaced left (S1040: NO), the corresponding constraint selection unit 340 selects, from the copy data, a constraint pair that is capable of canceling the loop by the deletion thereof and having a minimum total constraint strength (S1050). Such selection of the constraint pair can be made by using the already-described exhaustive search, for example. Even with the use of such technique, the copy data subjected to various replacement and deletion processing has a smaller scale than the original constraint data, and therefore processing can be completed in a practical calculation time.

Instead of this, the corresponding constraint selection unit 340 may select the constraint pair having a minimum total constraint strength by various techniques such as dynamic programming. Furthermore, the corresponding constraint selection unit 340 may select the constraint pair by other techniques, which may not be the minimum logically, as long as the total constraint strength can be minimized approximately.

Then, the corresponding constraint selection unit 340 selects a set represented by the above Eown1 that corresponds to each constraint included in the thus selected constraint pair as a set of constraints to be deleted from the original constraint data.

However, there is a case where as a result of various deletion processing by the deletion unit 330, the loop has been already canceled on the copy data. For instance, there is a case where various deletion processing results in two nodes and one edge connecting these nodes only included in the copy data. In this case, the corresponding constraint selection unit 340 selects a set of the constraints that have been deleted by the various deletion processing as a set of the constraints to be deleted from the original constraint data. For instance, in the case where the copy data includes only one edge, the corresponding constraint selection unit 340 selects a set represented by the above Eown2 corresponding to that edge as a set of the constraints to be deleted from the original constraint data.

Note here that the constraint to be deleted is selected from constraints of a nature that generate a return unless they are satisfied and not from constraints of a nature that have to be satisfied.

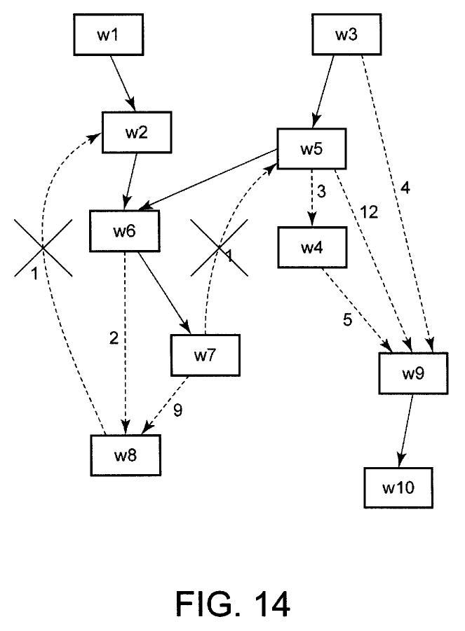

The description returns to FIG. 4. Next, the output unit 350 deletes the constraint pair selected by the selection unit 320 from the constraint data (S440). Then, the output unit 350 displays the constraint data from which the constraint pair has been deleted on a display unit, for example, thus outputting the same to the user (S450). FIG. 14 illustrates an example of the output.

FIG. 14 illustrates an exemplary constraint graph output from the output unit 350 of the present embodiment. As compared with the constraint graph of FIG. 2B, a part of the constraint is deleted. More specifically, the constraint that the design process w2 receives from the design process w8 and the constraint that the design process w5 receives from the design process w7 are deleted. As a result, the loop of the constraint relationship among the design processes can be cancelled, whereby the user can easily recognize what design process is to be processed first.

Further, in order to improve the convenience for users, the output unit 350 may display the constraint graph as in the following two examples:

(1) Displaying Process-Able Process

At a respective stage of the development, the input unit 300 receives an input of a design process that has been already completed. For instance, the input unit 300 may receive an input indicating that the design processes w1, w2, and w3 have been completed. Then, the output unit 350 selects, in the constraints indicated by the constraint data, a design process that receives constraints from these design processes that have been already completed and do not receive a constraint from a design process that has not been completed.

In this example, the design process w2 receives the constraint from the design process w1 that has been already completed, but does not receive a constraint from any other design processes. Therefore, the output unit 350 selects the design process w2. Further, the design process w5 receives the constraint from the design process w3 that has been already completed, but does not receive a constraint from any other design processes. Therefore, the output unit 350 selects the design process w5.

On the other hand, the design process w6 receives the constraint from the design process w2 that has been already completed, and also receives a constraint from the design process w5 that has not been completed yet. Thus the output unit 350 does not select the design process w6. Similarly, the design process w9 receives the constraint from the design process w3 that has been already completed, and also receives a constraint from the design process w5 that has not been completed yet. Thus the output unit 350 does not select the design process w9.

Then, the output unit 350 displays these selected design processes to be identifiable from other design processes. For instance, the output unit 350 may display the nodes indicating the design processes w2 and w5 to be colored with a color different from that for the other design processes. Alternatively, the output unit 350 may display the nodes indicating the design processes w2 and w5 to flash on and off, or may display these nodes in a larger size than the nodes indicating other design processes.

Thereby, the user can precisely recognize what design process is to be conducted next to improve efficiency.

(2) Displaying Violative Constraint

Similarly to the example of (1), at a respective stage of the development, the input unit 300 receives an input of the design process that has been already completed. For instance, the input unit 300 may receive an input indicating that the design processes w1, w6, and w3 have been completed. Then, the output unit 350 judges whether, in the constraints indicated by the constraint data, a design process that has been already completed receives a constraint from a design process that has or has not been completed.

The output unit 350 judges whether the design process that has been already completed receives a constraint from a design process that has not been completed. For instance, the design process w6 that has been already completed receives a constraint from the design process w2 that has not been completed. Thus, the output unit 350 displays such a constraint in a manner identifiable from other constraints. For instance, the output unit 350 may display such a constraint in a color different from that for other constraints, or may display it in a different manner, for example, with an arrow in a bold line.

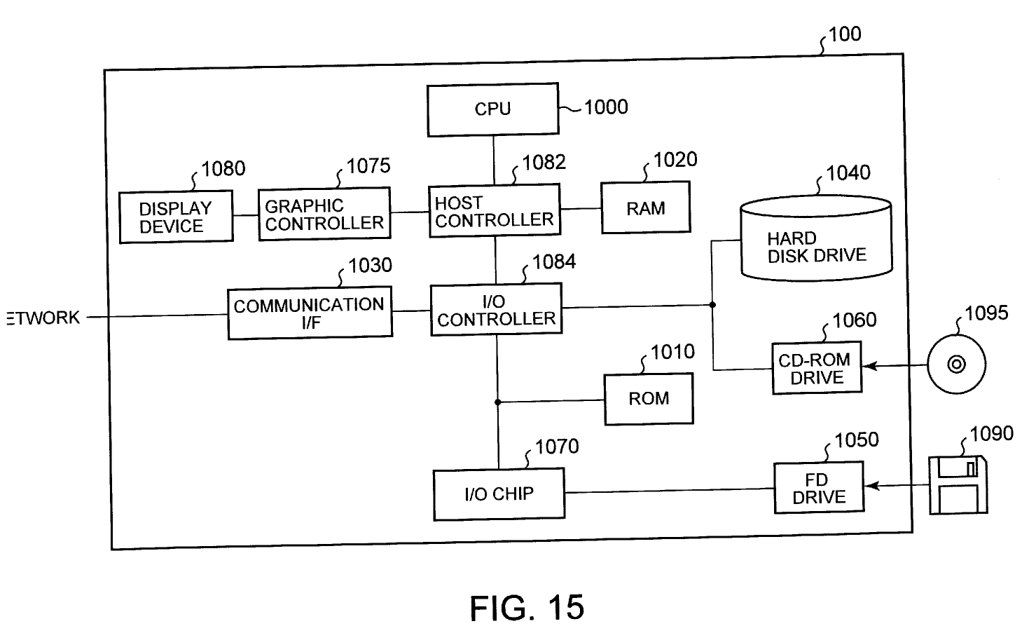

FIG. 15 shows an exemplary hardware configuration of a computer 100 according to the present embodiment. The computer 100 includes a CPU peripheral section including a CPU 1000, a RAM 1020, and a graphic controller 1075 mutually connected via a host controller 1082, an input/output section including a communication interface 1030 connected with the host controller 1082 via an input/output controller 1084, a hard disk drive 1040 and a CD-ROM drive 1060, and a legacy input/output section including a ROM 1010, a flexible disk drive 1050 and an input/output chip 1070 connected with the input/output controller 1084.

The host controller 1082 connects the RAM 1020 with the CPU 1000 accessing the RAM 1020 at a high transfer rate and the graphic controller 1075. The CPU 1000 operates in accordance with a program stored in the ROM 1010 and the RAM 1020 to control the respective sections. The graphic controller 1075 acquires image data generated by the CPU 1000 or the like on a frame buffer provided in the RAM 1020 and makes a display device 1080 display the image data. Instead, the graphic controller 1075 may include a frame buffer therein that is for storing image data generated by the CPU 1000 or the like.

The input/output controller 1084 connects the host controller 1082, the communication interface 1030 that is a relatively high-speed input/output device, the hard disk drive 1040 and the CD-ROM drive 1060. The communication interface 1030 is one example of the communication interface 102, which communicates with external devices via a network. The hard disk drive 1040 is one example of the storage device 104, which stores a program and data used by the computer 100. The CD-ROM drive 1060 reads out a program or data from a CD-ROM 1095 and provides the same to the RAM 1020 or the hard disk drive 1040.

The input/output controller 1084 is further connected with the ROM 1010 and relatively low-speed input/output devices such as the flexible disk drive 1050 and the input/output chip 1070. The ROM 1010 stores a boot program that the CPU 1000 executes during start-up of the computer 100, a program depending on the hardware of the computer 100 and the like. The flexible disk drive 1050 reads out a program or data from a flexible disk 1090 and provides the same to the RAM 1020 or the hard disk drive 1040 via the input/output chip 1070. The input/output chip 1070 connects the flexible disk 1090 and various input/output devices via a parallel port, a serial port, a keyboard port, a mouse port or the like.

Programs provided to the computer 100 are stored in a recording medium such as the flexible disk 1090, the CD-ROM 1095, or an IC card and are provided by a user. The programs are read out from the recording medium via the input/output chip 1070 and/or the input/output controller 1084 and are installed in the computer 100 for execution. Since the operations that the programs execute in computer 100 are the same as the support system 106 described in FIGS. 1 to 14, the description thereof has been omitted.

The above-stated programs may be stored in an external storage medium. An optical recording medium such as a DVD or a PD, a magneto optical recording medium such as a MD, a tape medium, a semiconductor memory such as an IC card and the like are available as storage media in addition to the flexible disk 1090 and the CD-ROM 1095. Alternatively, a storage device such as a hard disk or RAM provided in a server system connected with the exclusive communication network or the Internet may be used as the recording medium, and programs may be provided to the computer 100 via the network.

In this way, the present invention has been described by way of embodiments. However, the technical scope of the present invention is not limited to the above-described embodiments. It will be appreciated for a person skilled in the art that the above-stated embodiments can be modified or improved in various ways. It should be understood from appended claims that such modified or improved embodiments also fall within the technical scope of the present invention.

We claim:

1. A system for supporting determination of a design process order, the system comprising:
a storage device for storing constraint data indicating a strength of a constraint that is given to a respective design process from a respective of the other design processes;
a detection unit for accessing the storage device to detect, from the constraint data, a loop of relationships concerning a design process receiving a constraint from another design process;
a selection unit for accessing the storage device to select, from the detected loop, a pair capable of canceling the loop when the pair is deleted and having a minimum total constraint strength; and
an output unit for deleting the selected constraint pair from the constraint data and outputs data indicating a constraint that is to be satisfied by each design process.

2. The system according to claim 1, wherein the constraint data indicates a constraint of a nature that, unless the constraint is satisfied, a return occurs, and the storage device stores, as the strength of the constraint, a time required for the return to occur.

3. The system according to claim 2, wherein the constraint data further indicates a constraint of a nature that has to be satisfied, and the selection unit selects a pair having a minimum total constraint strength from a constraint of a nature that a return occurs unless the constraint is satisfied.

4. The system according to claim 3, further comprising an input unit that, if all constraints included in the detected loop are of a nature that has to be satisfied, receives an input for changing the constraint data stored in the storage device.

5. The system according to claim 2, wherein the selection unit comprises:
a copy unit for generating copy data that is a copy of the constraint data and stores the same in the storage device;
a deletion unit for deleting in accordance with a predetermined procedure, from the copy data, a design process and a constraint that do not affect a strength of a constraint to be deleted for cancelling the loop; and
a corresponding constraint selection unit for selecting, from the copy data from which the design process and the constraint have been deleted, a constraint pair capable of canceling the loop when the pair is deleted, and having a minimum total constraint strength, and that selects, from the constraint data, a constraint pair corresponding to the selected constraint pair.

6. The system according to claim 5, wherein the deletion unit detects, from the copy data, a design process that receives a constraint from at least any one design process and does not impose a constraint on any other design processes, or a design process that imposes a constraint on at least any one design process and does not receive a constraint from any other design processes, and deletes the detected design process and a constraint between the detected design process and another design process from the copy data.

7. The system according to claim 5, wherein a first design process receives a constraint of a first strength from a second design process, and the second design process receives a constraint of a second strength from the first design process, and if the first strength is larger than the second strength, the deletion unit replaces the constraints with the first strength and the second strength with a constraint of a strength corresponding to a difference between the first and the second strengths that the second design process receives from the first design process.

8. The system according to claim 5, wherein a fourth design process receives a constraint of a third strength from a third design process, and a fifth design process receives a constraint of a fourth strength from the fourth design process, and if the fourth design process does not receive a constraint from any other design processes and does not impose a constraint on any other design processes, the deletion unit replaces the constraints of the third strength and the fourth strength with a smaller one between the constraints of the third strength and the fourth strength that the fifth design process receives from the third design process.

9. The system according to claim 5, wherein the deletion unit repeats a first deletion process, a second deletion process and a third deletion process with respect to the copy data until no design process capable of being deleted or replaced is left:
in the first deletion processing, a design process that receives a constraint from at least any one design process and does not impose a constraint on any other design processes or a design process that imposes a constraint on at least any one design process and does not receive a constraint from any other design process is detected from the copy data, and the detected design process and a constraint relationship between the design process and another design process are deleted from the copy data;
in the second deletion processing, when a first design process receives a constraint of a first strength from a second design process, and the second design process receives a constraint of a second strength from the first design process, if the first strength is larger than the second strength, the constraints with the first strength and the second strength are replaced with a constraint of a strength corresponding to a difference between the first and the second strengths that the second design process receives from the first design process; and
in the third deletion processing, when a fourth design process receives a constraint of a third strength from a third design process, and a fifth design process receives a constraint of a fourth strength from the fourth design process, if the fourth design process does not receive a constraint from any other design process and does not impose a constraint on any other design processes, the constraints of the third strength and the fourth strength are replaced with a smaller one between the constraints of the third strength and the fourth strength that the fifth design process receives from the third design process.

10. The system according to claim 3, wherein an eighth design process receives, from a sixth design process, a constraint of a nature that has to be satisfied, a seventh design process receives, from the sixth design process, a constraint of a nature that has to be satisfied, and the eighth design process receives, from the seventh design process, a constraint of a nature that has to be satisfied necessarily if the seventh design process does not receive a constraint from any other design processes, and the seventh design process does not impose a constraint on any other design processes, the detection unit deletes, from the constraint data, the constraint that the eighth design process receives from the sixth design process, and detects a loop of relationships of receiving a constraint from the constraint data from which the constraint data has been deleted.

11. The system according to claim 3, wherein if each of a constraint of a nature that has to be satisfied necessarily and a constraint of a nature that returning occurs unless it is satisfied exists between a design process and another design process, the detection unit deletes the constraint of a nature that a return occurs unless it is satisfied from the constraint data, and detects a loop of relationships of receiving a constraint from the constraint data from which the constraint data has been deleted.

12. The system according to claim 1, further comprising an input unit that receives an input of a design process that has been already completed, wherein the output unit displays the constraint data from which the constraint pair selected by the selection unit has been deleted, while displaying so that a design process that receives a constraint of the design process that has been already completed but does not receive a constraint of a design process that has not been completed is indicated by the constraint data.

13. The system according to claim 1, further comprising an input unit that receives an input of a design process that has been already completed, wherein the output unit displays the constraint data from which the constraint pair selected by the selection unit has been deleted, while displaying data that indicates the constraint if the design process that has been already completed receives a constraint of a design process that has not been completed.

14. The system according to claim 1, wherein the storage device stores a graph as the constraint data, in which a respective constraint is represented so that a respective design process is a node and a strength of a constraint from a design process imposing a constraint to a design process receiving the constraint is a directed edge with a constraint strength as a weight;
wherein the detection unit detects a loop from the graph;
wherein the selection unit selects, from the detected loop, a pair of a directed edge capable of canceling the loop when the pair is deleted and having a minimum total weight; and
wherein the output unit deletes the selected directed edge pair from the graph and outputs a graph indicating a constraint that is to be satisfied by each design process.

15. A program product that makes a computer function as a system that supports determination of a design process order, wherein the program product causes the computer to function as:
a storage device for storing constraint data indicating a strength of a constraint that is given to a respective design process from a respective of the other design processes;
a detection unit for accessing the storage device to detect, from the constraint data, a loop of relationships concerning a design process receiving a constraint from another design process;
a selection unit for accessing the storage device to select, from the detected loop, a pair capable of canceling the loop when the pair is deleted and having a minimum total constraint strength; and
an output unit for deleting the selected constraint pair from the constraint data and outputs data indicating a constraint that is to be satisfied by each design process.

16. A method for supporting determination of a design process order by a computer, the computer comprising a storage device that stores constraint data indicating a strength of a constraint that is given to a respective design process from a respective of the other design processes, the method comprising the steps of:
accessing the storage device to detect, from the constraint data, a loop of relationships concerning a design process receiving a constraint from another design process;
accessing the storage device to select, from the detected loop, a pair capable of canceling the loop when the pair is deleted and having a minimum total constraint strength; and
deleting the selected constraint pair from the constraint data and outputting data indicating a constraint that is to be satisfied by each design process.
